(19) United States
(12) Patent Application Publication
(10) Pub. No.: US 2005/0096010 A1
(43) Pub. Date: May 5, 2005

(54) Wireless service sharing between multiple mobile devices of a party

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Docket Administrator (Room 3J-219);Lucent Technologies Inc., 101 Crawfords Corner Road, Holmdel, NJ, 07733-3030, US

(21) Appl. No.: 10/701,145

(22) Filed: Nov. 4, 2003

(51) Int. Cl. H04M 11/00

(52) U.S. Cl. 455/406; 455/405; 455/407

(57) ABSTRACT

A communication network supports a service sharing arrangement with multiple mobile devices of a party covered under the same service plan. The service sharing arrangement allows for the same directory number and same billing criteria for each of the multiple devices and provides for selectable activation of the devices so as to reduce or eliminate service conflicts and user confusion.

### FIELD OF THE INVENTION

This invention relates generally to the field of communication systems and, more particularly, to methods for sharing wireless service between multiple wireless communication units of a party.

### BACKGROUND OF THE INVENTION

Communication systems are well known in which persons may initiate or receive calls using wireless communication units (e.g., mobile phones). Most typically, the call is a voice communication, but other forms of wireless service (e.g., paging, short message service, e-mails, etc.) are also known. The communication units wirelessly communicate, using radio frequency (RF) communication resources, with base stations that are geographically distributed among various sites. The base stations are connected to a call processing control entity, commonly known as Mobile Switching Center (MSC), which coordinates calls and allocates communication resources for the communication units as they roam from site to site or even to different communication networks.

As wireless communication has grown in popularity, it is envisioned that persons will carry multiple mobile devices within their vehicle or on their person. The devices may comprise the same or different types of devices comprising, without limitation, mobile phones, pagers, personal digital assistants, laptop computers and the like. Presently, however, wireless service providers do not allow multiple devices per service plan. Hence, persons with multiple mobile devices must initiate separate service plans (possibly with different service providers), yielding separate directory numbers and separate billing criteria, accumulated minutes, etc. for each mobile device. Further, it is possible that service conflicts may occur between different devices initiating or receiving calls at the same time, thereby creating confusion and frustration for the user.

### SUMMARY OF THE INVENTION

These problems are solved and a technical advance is achieved in the art by a feature whereby a communication network infrastructure supports a service sharing arrangement with multiple mobile devices of a party covered under the same service plan. Advantageously, the service sharing arrangement allows for the same directory number and same billing criteria for each of the multiple devices covered under the service plan and an aggregate accumulation of minutes. Further, the service sharing arrangement provides for user-selectable activation of the devices so as to reduce or eliminate service conflicts and user confusion between the multiple devices.

In one embodiment, a method of the invention comprises maintaining a subscriber database including indicia of multiple communication units of a subscriber. Optionally, the multiple communication units may share the same directory number. An active unit is designated from among the multiple communication units and so identified in the subscriber database, and service is provided to the active unit. The active unit may be changed from time to time responsive to subscriber input, in which case the new active unit is so designated in the subscriber database and service provided to the new active unit. Service includes, for example, receiving call requests directed to the directory number, consulting the database to determine the active unit, routing the call to the active unit, obtaining billing information associated with the call and recording the billing information in the subscriber database.

In another embodiment, a method of the invention is adapted for use in a communication system including a plurality of wireless communication units operably connected to a mobile switching center (MSC), whereby two or more units of the plurality of wireless units share the same directory number. The method comprises the MSC receiving a call request directed to the directory number and consulting a database to determine a multiple device feature status associated with the directory number. If the multiple device feature is enabled, the MSC consults the database to determine an active unit from among the two or more units sharing the directory number and then routes the call to the active unit.

In yet another embodiment, a method of the invention is adapted for use in a communication system providing a service to a subscriber under a wireless service plan, the wireless service plan having one or more service thresholds. A subscriber database is maintained including indicia of multiple wireless units of the subscriber sharing the wireless service plan. Subscriber activity among the multiple wireless units (i.e., a collective amount of service provided to the wireless units within a billing period associated with the wireless service plan) is monitored relative to the one or more service thresholds and billed according to the wireless service plan.

### BRIEF DESCRIPTION OF THE DRAWINGS

The foregoing and other advantages of the invention will become apparent upon reading the following detailed description and upon reference to the drawings in which:

FIG. 1 is a block diagram of a communication system operable to implement wireless service sharing among multiple user devices according to embodiments of the invention;

FIG. 2 is a flowchart of a method for a service provider to identify active devices from among multiple user devices sharing a wireless service; and

FIG. 3 is a flowchart of a method for routing a call to an active device selected from among multiple devices sharing a wireless service.

### DESCRIPTION OF THE PREFERRED EMBODIMENT(S)

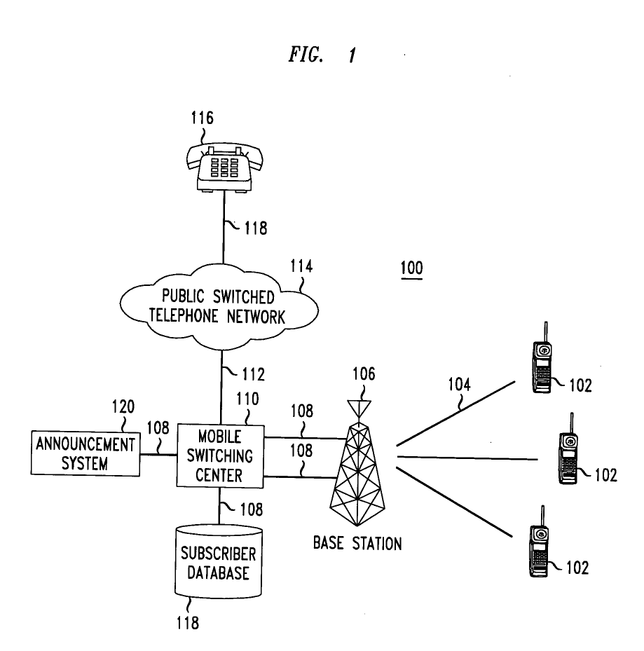

FIG. 1 depicts a communications system 100 including a plurality of wireless units 102 (as shown, mobile phones) connected by RF resources 104 with one or more base stations 106. The base stations 106 are connected via links 108 to a call processing control entity, commonly known as Mobile Switching Center (MSC) 110. The MSC 110 may comprise, for example, a 5ESS® switching system, available from Lucent Technologies, Inc. The MSC 110 is connected via link 112 to the public switched telephone network (PSTN) 114, which is connected via link 108 to one or more wireline phones 116. Generally, therefore, the MSC 110 is connected to and may process calls between any combination of mobile and wireline phones.

The MSC 110 is further connected via links 108 to a subscriber database 118 and announcement system 120. Links 108 may comprise, without limitation, conventional subscriber line, ISDN line, Ethernet LAN or the like. Link 112 is a logical link that may be physically realized, without limitation, by conventional subscriber lines, ISDN lines, WAN links, wireless links, and the like.

To best illustrate principles of the present invention, the wireless units 102 are presumed to be owned/operated by the same party and sharing the same wireless service (and hence, the same service provider). The service provider provides resource allocation, call control and billing functionality for each of the wireless units 102. This functionality may reside within the MSC 110 alone or in combination with the subscriber database 118, announcement system 120 or other network devices (not shown). To that end, the MSC 110 includes a memory and processor (not shown), for storing and executing software routines for processing and switching calls, for providing various call features to the wireless units 102 and for providing access to the PSTN 114. The MSC 110 may be configured for operation with generally any suitable circuit, cell, or packet switching technology. As shown, the communication system 100 of FIG. 1 includes a single MSC 110. However, as will be appreciated, the MSC 110 is a functional entity that may reside in multiple physical devices or combined into a single device.

The subscriber database 118 stores information including subscriber data, service information and the like associated with the wireless units 102. The subscriber database includes a service control point SCP (not shown), which enables service providers to access and modify the information in the subscriber database as needed. Alternatively or additionally, the SCP may reside within the MSC 110. As will be appreciated, the SCP and subscriber database may reside within separate physical devices or structures. For convenience, the subscriber database will hereinafter be understood to encompass both SCP and information storage functionality.

In one embodiment, the subscriber information includes, for multiple subscribers, indicia of wireless units 102 associated with the different subscribers; indicia of which of the wireless units are “active” (e.g., available to send and receive calls); and indicia of billing criteria and accumulated minutes associated with the wireless units. In the preferred embodiment, the multiple wireless units 102 associated with any given subscriber may share the same directory number, service plan and billing criteria. Optionally, the multiple wireless units may have different directory numbers yet share the same service plan and billing criteria.

In one embodiment, accumulated minutes are computed collectively among the multiple wireless units of a subscriber sharing the same service plan and directory number. Wireless service providers typically charge a monthly fee in return for certain “free” airtime minutes and charge additional fees if/when the subscriber's wireless phone usage exceeds the plan threshold. For instance, Sprint PCS offers a plan of 3500 minutes monthly, including 300 “any time minutes” and 3200 night and weekend minutes. Historically, to the extent a subscriber could possess multiple wireless units, each of the wireless units were associated with different directory numbers. According to embodiments of the present invention, a subscriber may possess multiple wireless units sharing the same directory number and service plan. Accumulated minutes are computed collectively among multiple wireless units of a subscriber and the subscriber is billed (or not) according to the collective accumulated minutes in relation to the service plan. Optionally, the accumulated minutes may further be broken down into minutes accumulated per individual device. For example, suppose a subscriber has two wireless units “A” and “B.” The subscriber database may indicate 100 accumulated “anytime” minutes collectively—60 minutes from unit A and 40 minutes from unit B. Thereafter, the subscriber is billed (or not) based on whether the 100 accumulated minutes exceeds or falls within the “free” airtime threshold of the shared plan.

As will be appreciated, service plan sharing, directory number sharing and/or accumulated billing features according to the present invention may not be implemented for all subscribers. It is contemplated that the features will be offered on an elective basis to subscribers (perhaps for a monthly fee) such that certain subscribers will choose to elect the features and certain subscribers will not. Further, depending on how the features are marketed, it is possible that certain subscribers will elect some but not all of the features. Accordingly, in one embodiment, the subscriber database 118 is adapted to identify activation status of each service for multiple subscribers, wherein the activation status may differ for different subscribers.

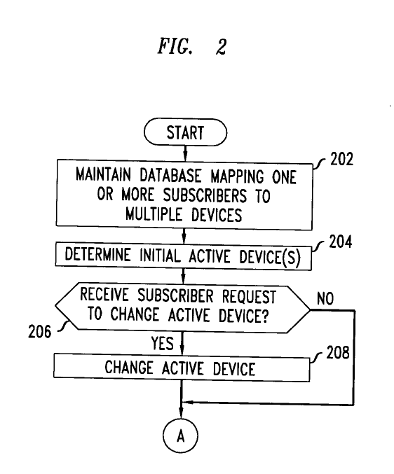

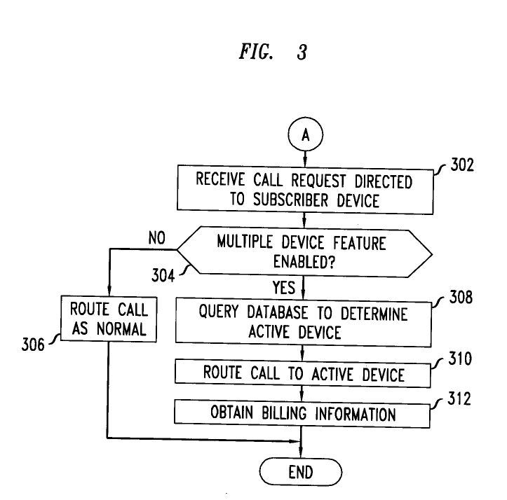

The announcement system 120 includes a memory and processor (not shown), for storing recorded announcements and playing announcements, on occasion, to the wireless units 102. For example, according to embodiments of the present invention, the announcements may provide service plan information; facilitate subscriber selection of “active” units from among multiple wireless units sharing a common service plan and/or directory number (FIG. 2) or may be provided in conjunction with routing calls to selected active units(s) (FIG. 3).

As will be appreciated, both the database 118 and announcement system 120 are logical entities that may be realized by unitary, centralized devices or multiple, distributed devices. The database 118 and announcement system 120 may be linked to the PSTN 114 rather than (or in addition to) the MSC 110.

Turning now to FIG. 2, there is shown a flowchart of a method that may be implemented in the communication system of the type shown in FIG. 1, for a service provider to track activation status of multiple subscriber units 102 sharing a common service plan. The steps of FIG. 2 are implemented, where applicable, using stored software routines within the subscriber units 102, MSC 110, subscriber database 118 and/or announcement system 120.

The method presumes at block 202, that the service provider maintains a database (e.g., subscriber database 118) mapping various subscribers to multiple wireless units 102. As has been described in relation to FIG. 1, the subscriber database 118 stores information including subscriber data, service information, directory numbers, billing criteria and accumulated minutes associated with the multiple wireless units 102. In one embodiment, the service provider enters and/or modifies the information via an SCP associated with the subscriber database.

In one embodiment, the subscriber database includes indicia of which units among multiple wireless units of a subscriber are active and hence available to send and receive calls. At step 204, the service provider determines initial active devices and so indicates the active devices in the subscriber database. Optionally, this may be accomplished responsive to service provisioning for particular wireless units or responsive to queries or transactions relating to particular subscribers. For example, a service provider may query a subscriber upon registration of a second wireless unit (i.e., the service provider having previously registered a first wireless unit for the subscriber) which of the first and second units is desired to be the active device. Most particularly in embodiments where multiple units of a subscriber share the same directory number, it is contemplated that the service provider will require selection of a single active unit from among the multiple subscriber units. Alternatively, the service provider may allow selection of multiple active units of a subscriber.

Thereafter, in one embodiment, changes to the active device are made responsive to subscriber request(s). The subscriber may invoke change requests by entering a code, pressing a button, using a point-and-click interface or using generally any other appropriate user interface available to the subscriber. Optionally, if the change requests are invoked from a subscriber phone, the announcement system may prompt the user for information associated with the change request. If the service provider receives a change request, determined at step 206, it accesses and changes the subscriber database accordingly to reflect the new or different active device(s).

Now referring to FIG. 3, there is shown a method for processing an incoming call to an active device selected from among multiple subscriber devices. In one embodiment, the steps of FIG. 3 are implemented by the MSC 110 executing stored subroutines and retrieving data within the subscriber database 118. At step 302, the MSC 110 receives a call request directed to a subscriber device. Conventionally, call requests are invoked by dialing a unique directory number associated with the subscriber device. However, embodiments of the present invention allow for sharing of a directory number between multiple devices, hence the directory number may not be uniquely associated to any particular device. At step 304, the MSC consults the subscriber database to determine if a multiple device feature associated with the directory number is enabled. If the multiple device feature is not enabled, the directory number is presumed to uniquely identify a particular subscriber device and at step 306, the MSC routes the call to the subscriber device in conventional fashion.

Conversely, if the multiple device feature is enabled, the directory number is presumed to be shared by multiple devices. At step 308, the MSC consults the subscriber database to determine which of the multiple devices is active. Having identified the active device, the MSC routes the call to the active device at step 310. At step 312, the MSC obtains billing information (accrued minutes, charges) associated with the call and updates the information as appropriate in the subscriber database. Over time, as different calls are completed to different active devices, the billing information includes an aggregate accumulation of minutes, charges, etc. for multiple subscriber devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising:
maintaining a subscriber database including indicia of multiple communication units of a subscriber;
determining an active unit of the multiple communication units;
designating the active unit in the subscriber database; and
providing service to the active unit.

2. The method of claim 1, wherein the step of determining an active unit is accomplished upon service provisioning of one of the multiple communication units.

3. The method of claim 1, wherein the step of determining an active unit is accomplished responsive to a subscriber selection of an active unit.

4. The method of claim 3, wherein the step of determining an active unit is periodically re-accomplished responsive to one or more subscriber requests to change active units.

5. The method of claim 4, comprising:
receiving a subscriber request to change designation of the active unit of the multiple communication units from a present active unit to a new active unit;
designating the new active unit in the subscriber database; and
providing service to the new active unit under the shared service plan.

6. The method of claim 1, wherein the subscriber database includes indicia of multiple communication units of a subscriber sharing a directory number, the step of determining an active unit comprises selecting, from among the multiple communication units, a single unit designated as the active unit.

7. The method of claim 6, wherein the step of providing service to the active unit comprises:
receiving a call request to the directory number;
consulting the database to determine the active unit of the multiple communication units; and
routing the call to the active unit.

8. The method of claim 7, wherein the step of providing service further comprises:
obtaining billing information associated with the call; and
recording the billing information in the subscriber database.

9. In a communication system including a plurality of wireless communication units operably connected to a mobile switching center (MSC), whereby two or more units of the plurality of wireless units share the same directory number, a method comprising the MSC performing steps of:
receiving a call request directed to the directory number;
consulting a database to determine a multiple device feature status associated with the directory number;
if the multiple device feature is enabled, consulting the database to determine an active unit from among the two or more units sharing the directory number; and
routing the call to the active unit.

10. In a communication system providing a service to a subscriber under a wireless service plan, the wireless service plan having one or more service thresholds, a method comprising:
maintaining a subscriber database including indicia of multiple wireless units of the subscriber sharing the wireless service plan;
monitoring subscriber activity among the multiple wireless units relative to the one or more service thresholds, the subscriber activity defining a collective amount of service provided to the multiple wireless units within a billing period associated with the wireless service plan; and
billing the subscriber activity according to the wireless service plan.
